(19) United States
(12) Patent Application Publication
(10) Pub. No.: US 2022/0366250 A1
(43) Pub. Date: Nov. 17, 2022

(54) METHOD FOR DISTRIBUTING LABELING WORK ACCORDING TO DIFFICULTY THEREOF AND APPARATUS USING SAME

(71) Applicant: SELECT STAR, INC., Daejeon (KR)

(72) Inventors: Se Yeob KIM, Seoul (KR); BaRom KANG, Incheon (KR)

(21) Appl. No.: 17/771,474

(22) PCT Filed: Oct. 20, 2020
(86) PCT No.: PCT/KR2020/014338

§ 371 Date: Apr. 24, 2022

(30) Foreign Application Priority Data
Dec. 13, 2019 (KR) 10-2019-0166420

(51) Int. Cl. G06N 3/08

(52) U.S. Cl. CPC G06N 3/08

(57) ABSTRACT

The present invention proposes a method for distributing labeling work, wherein a computing apparatus uses a deep learning model performing bounding box labeling work, in order to find the position of an object included in an image and classify the type of the object, the method comprising the steps of: obtaining a predetermined image including at least one object by the computing apparatus; performing calculation, by the computing apparatus, while passing the predetermined image through the deep learning model, to obtain i) the coordinates of a bounding box with respect to the at least one object, ii) a classification value indicating the type of the at least one object, and iii) a loss value indicating the degree of error of the obtained bounding box; and determining, by the computing apparatus, difficulty levels of labeling work on the basis of the loss value and the classification value, and distributing the labeling work to workers according to the determined difficulty levels.

### TECHNICAL FIELD

The present invention relates to a method for distributing a labeling work, in which a computing apparatus uses a deep learning model for finding a position of an object included in an image in a form of a bounding box and classifying a type of the object, the method including: obtaining, by the computing apparatus, a predetermined image including at least one object; performing, by the computing apparatus, calculation while passing the predetermined image through the deep learning model to calculate i) a coordinate of a bounding box for the at least one object, ii) a classification value representing a type of the at least one object, and iii) a loss value representing coordinate and classification error degrees of a calculated bounding box; and determining, by the computing apparatus, a difficulty level of the labeling work based on the loss value and the classification value, and distributing the labeling work to a worker according to the determined difficulty level.

### BACKGROUND ART

As the artificial intelligence develops, an image recognition technology for more accurately recognizing an object included in a video, an image, or the like has been developed. In this case, the image recognition technology may collect various data from a deep learning model and require an iterative training process based on the collected data. Regarding the training process, correct answer data that is a comparison target may be required, and the correct answer data may be usually collected from labeling works of a worker.

In addition, a plurality of workers may be required in order to obtain a plurality of correct answer data, and performance of a labeling work appropriate for skill of each worker may be required for an efficient work.

Accordingly, the present inventor intends to propose a method for distributing a labeling work according to work difficulty and an apparatus using the same.

### DISCLOSURE

### Technical Problem

An object of the present invention is to solve all the problems described above.

Another object of the present invention is to more efficiently collect correct answer data required for a training process in a deep learning model.

In addition, still another object of the present invention is to improve task processing ability of a worker by differentially providing a reward according to work difficulty.

### Technical Solution

A characteristic configuration of the present invention for achieving the objects of the present invention described above and implementing characteristic effects of the present invention that will be described below is as follows.

According to one aspect of the present invention, there is provided a method for distributing a labeling work, in which a computing apparatus uses a deep learning model for finding a position of an object included in an image in a form of a bounding box and classifying a type of the object, the method including: obtaining, by the computing apparatus, a predetermined image including at least one object; performing, by the computing apparatus, calculation while passing the predetermined image through the deep learning model to calculate i) a coordinate of a bounding box for the at least one object, ii) a classification value representing a type of the at least one object, and iii) a loss value representing coordinate and classification error degrees of a calculated bounding box; and determining, by the computing apparatus, a difficulty level of the labeling work based on the loss value and the classification value, and distributing the labeling work to a worker according to the determined difficulty level.

In addition, according to another aspect of the present invention, there is provided a computing apparatus, which is an apparatus for distributing a labeling work, in which the computing apparatus uses a deep learning model for finding a position of an object included in an image in a form of a bounding box and classifying a type of the object, the computing apparatus including: a communication unit for obtaining a predetermined image including at least one object; and a processor for performing calculation while calculating the predetermined image through the deep learning model to calculate i) a coordinate of a bounding box for the at least one object, ii) a classification value representing a type of the at least one object, and iii) a loss value representing coordinate and classification error degrees of a calculated bounding box, determining a difficulty level of the labeling work based on the loss value and the classification value, and distributing the labeling work to a worker according to the determined difficulty level.

### Advantageous Effects

According to the present invention, the following effects can be obtained.

According to the present invention, correct answer data required for a training process in a deep learning model can be more efficiently collected.

In addition, according to the present invention, task processing ability of a worker can be improved by differentially providing a reward according to work difficulty.

### DESCRIPTION OF DRAWINGS

FIG. 1 is a view showing a concept of a labeling work according to one embodiment of the present invention.

FIG. 2 is a view showing a training process of a deep learning model according to one embodiment of the present invention.

FIG. 3 is a view showing a schematic configuration of a computing apparatus according to one embodiment of the present invention.

FIG. 4 is a view showing a process for distributing the labeling work to a worker according to one embodiment of the present invention.

FIG. 5 is a view showing a process of training a deep learning model through a loss value and an actual loss value according to one embodiment of the present invention.

FIG. 6 is a view showing a state in which a difficulty level of the labeling work is determined according to one embodiment of the present invention.

FIG. 7 is a view showing a state in which a plurality of labeling works are displayed according to one embodiment of the present invention.

### MODE FOR INVENTION

The following detailed descriptions of the present invention are given for specific embodiments in which the present invention may be practiced with reference to the accompanying drawings that illustrate the specific embodiments. These embodiments are described in sufficient detail to enable those skilled in the art to practice the present invention. It should be understood that various embodiments of the present invention are different from each other, but need not be mutually exclusive. For example, specific shapes, structures, and characteristics described herein may be implemented and changed from one embodiment to another embodiment without departing from the idea and scope of the present invention. In addition, it should be understood that locations or arrangements of individual elements within each embodiment described herein may be changed without departing from the idea and scope of the present invention. Therefore, the following detailed description is not intended to be taken in a limiting sense, and the scope of the invention is defined only by the appended claims while encompassing the scope of all equivalents of the claimed invention when appropriately described. In the drawings, like reference numerals refer to elements that perform like or similar functions in various aspects.

Hereinafter, in order to enable a person having ordinary skill in the art to which the present invention pertains to easily practice the present invention, preferred embodiments of the present invention will be described in detail with reference to the accompanying drawings.

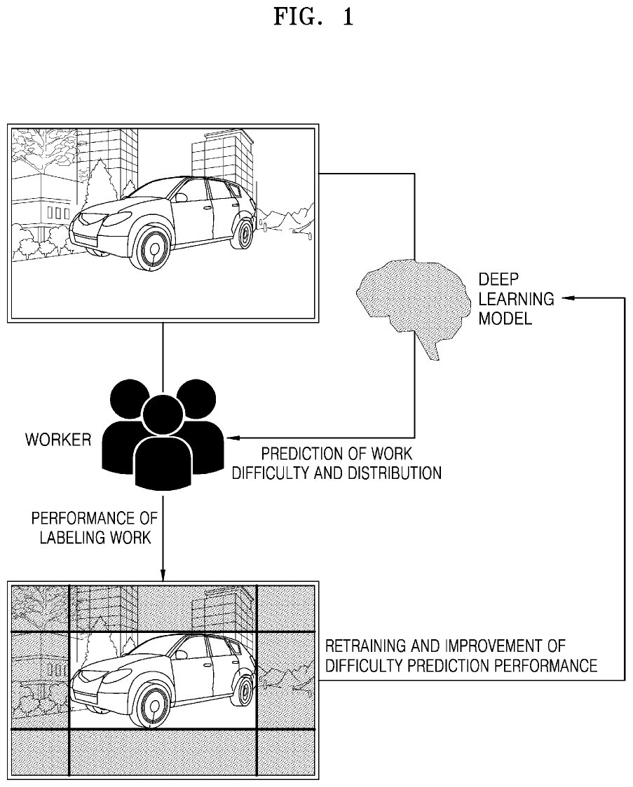

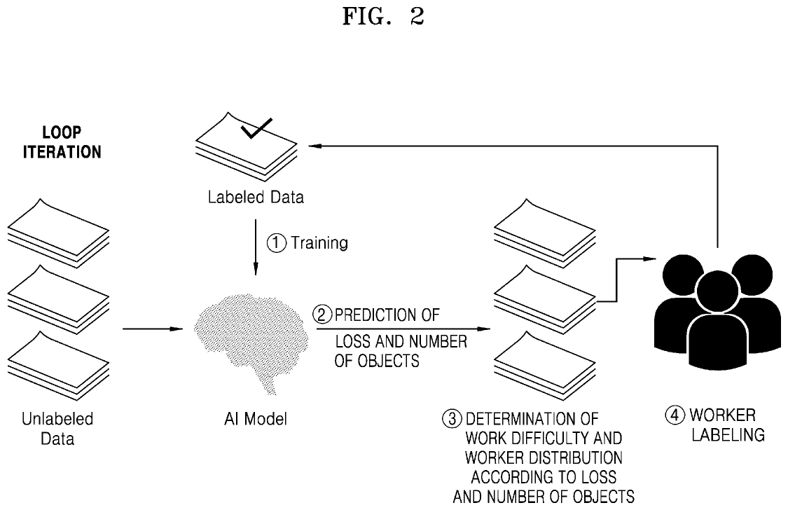

FIG. 1 is a view showing a concept of a labeling work according to one embodiment of the present invention. FIG. 2 is a view showing a training process of a deep learning model according to one embodiment of the present invention.

According to the present invention, it may be considered to use a deep learning model for recognizing an object included in a video, an image, or the like, and performing a corresponding work in order to find a position of the object and accurately classify a type of the object.

In particular, the deep learning model may be designed to simultaneously find the position of the object, classify the type of the object, and predict work difficulty so as to enable efficient labeling and worker arrangement. Therefore, the deep learning model may be trained whenever a labeling work is completed, so that performance and work efficiency may be improved.

As shown in FIG. 1, the work difficulty may be predicted by using the deep learning model for an object included in any one video, image, or the like, and the labeling work may be distributed to workers according to the predicted work difficulty.

In this case, the work difficulty may be determined according to a predicted error degree of a bounding box generated by the deep learning model, and details thereof will be described below.

The deep learning model according to the present invention may distribute the labeling work to the workers according to the work difficulty, and the worker may generate an accurate bounding box for the object by performing the labeling work.

The generated accurate bounding box (labeled data) may be used to train the deep learning model and improve difficulty prediction performance.

The deep learning model used in the present invention may vary according to a use or the like, and the use may include various uses such as an autonomous driving use, a garment photograph use, and a general use. In other words, the deep learning model and a training process for the deep learning model may vary according to the use or the like.

The training process may also be found through FIG. 2.

In detail, primary data before labeling may be used to generate labeled data through the labeling work of the worker. The deep learning model may be initially trained by using the labeled data, and another unlabeled secondary data may be input and calculated by using the initially trained deep learning model.

As a result of calculation in the deep learning model, a coordinate of a bounding box, a type of an object, a loss value representing predicted coordinate and classification error degrees of a calculated bounding box, and the like may be derived. According to one embodiment, the loss value may be derived through a function using a predicted error degree of each of the coordinate and a classification of the bounding box as a variable.

In addition, as will be described below, only some of objects included in the secondary data may be selected based on a classification value corresponding to the type of the object, and a number of the selected objects (number of objects) may be derived.

Next, the deep learning model may determine the work difficulty based on the derived loss value and the derived number of the objects, and distribute the labeling work to the workers according to the work difficulty so that the worker may perform the labeling work.

Data that may provide most assistance to training may be selected among data calculated by the deep learning model, and the deep learning model may be retrained again through the labeling work of the worker.

For reference, the data that may provide most assistance to the training may correspond to data having a greatest error with respect to correct answer data among the data calculated by the deep learning model. This indicates that it may be difficult to find the position of the object included in the image or to distinguish the type of the object, which will be described below.

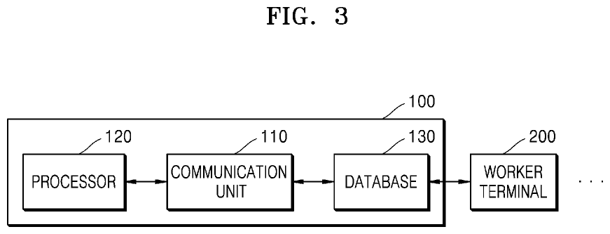

FIG. 3 is a view showing a schematic configuration of a computing apparatus according to one embodiment of the present invention.

According to the present invention, a computing apparatus 100 for controlling a deep learning model and the like may include a communication unit 110 and a processor 120. In some cases, unlike FIG. 3, the computing apparatus 100 may not include a database 130.

First, the communication unit 110 of the computing apparatus 100 may be implemented with various communication technologies. In other words, Wi-Fi, wideband CDMA (WCDMA), high speed downlink packet access (HSDPA), high speed uplink packet access (HSUPA), high speed packet access (HSPA), mobile WiMAX, WiBro, long term evolution (LTE), 5G, Bluetooth, infrared data association (IrDA), near field communication (NFC), Zigbee, a wireless LAN technology, and the like may be applied to the communication unit 110. In addition, when the communication unit 110 is connected to the Internet to provide a service, the communication unit 110 may conform to TCP/IP, which is a standard protocol for information transmission on the Internet.

Next, according to the present invention, the database 130 may store obtained data (e.g., data information labeled by the worker, etc.). For reference, when an external database is used, the computing apparatus 100 may access the external database through the communication unit 110.

In addition, the computing apparatus 100 may communicate with a worker terminal 200 through the communication unit 110. In this case, any digital device configured to perform communication, having a memory device, and equipped with a microprocessor to have calculation ability, such as a desktop computer, a laptop computer, a workstation, a PDA, a web pad, a mobile phone, a smart remote control, or various IoT main devices, may correspond to the worker terminal 200 according to the present invention.

Meanwhile, the processor 120 may perform calculation and the like in the deep learning model, which will be described in detail below.

For reference, the deep learning model according to the present invention may include a convolution layer and a fully connected (FC) layer. In this case, the FC layer may perform calculation by using a result value calculated in the convolution layer.

In addition, the deep learning model may receive the image, and perform calculation to generate a bounding box for an object included in the image, determine a type of the object, and predict an error degree of the generated bounding box.

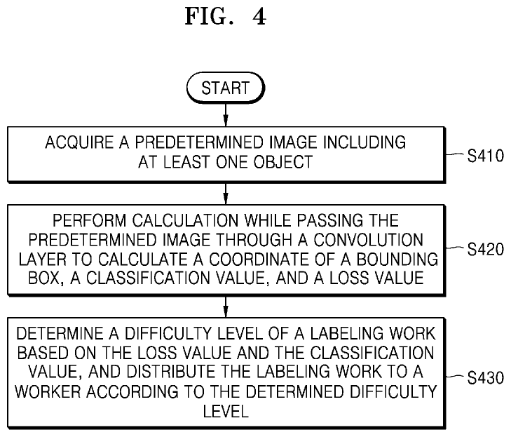

FIG. 4 is a view showing a process for distributing the labeling work to a worker according to one embodiment of the present invention.

The processor 120 of the computing apparatus 100 may obtain a predetermined image including at least one object (S410). The object may be various objects such as a vehicle, a tree, a road, and a person, and the predetermined image may include at least one of various types of objects.

Next, the processor 120 of the computing apparatus 100 may perform calculation while passing the predetermined image through the deep learning model to calculate a coordinate of a bounding box for the at least one object, a classification value representing a type of the at least one object, and a loss value representing an error degree of a calculated bounding box (S420).

In detail, calculation may be performed while passing the predetermined image through the convolution layer (which may include a plurality of layers), and a result value of the calculation may be used to perform calculation in the FC layer to calculate the coordinate of the bounding box, the loss value, and the classification value.

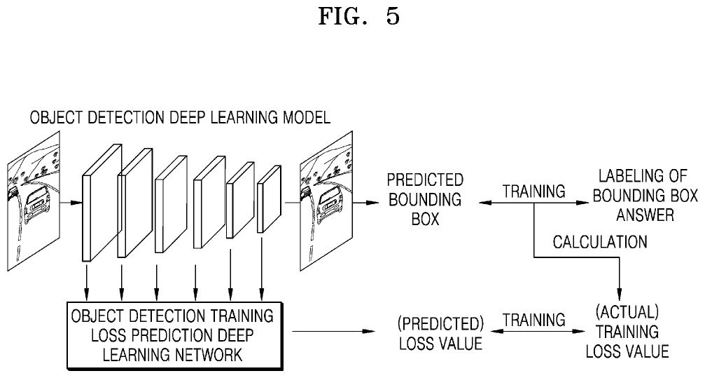

For reference, the (predicted) loss value may be a value predicted in the deep learning model, and may be calculated based on the generated bounding box (including coordinate information). This will be described with reference to FIG. 5.

FIG. 5 is a view showing a process of training a deep learning model through a loss value and an actual loss value according to one embodiment of the present invention.

The processor 120 may calculate a first bounding box value (predicted bounding box of FIG. 5) for the at least one object included in the predetermined image through the calculation in the FC layer, and may compare the calculated bounding box value with a second bounding box value (bounding box correct answer labeling of FIG. 5) of a ground truth (GT) corresponding to the at least one object.

For reference, as shown in FIG. 1, the bounding box may refer to a box that recognizes the object (e.g. a vehicle) and matches a size of the object. A calculated bounding box value may include information such as a coordinate (e.g., a center coordinate, a corner coordinate, etc.) or a size (e.g., lateral, longitudinal, diagonal lengths, etc.) of the bounding box.

The first bounding box may be generated through the calculation in the deep learning model, and may have an error with respect to an actual object size. Meanwhile, the second bounding box of the GT may be generated through the labeling work of the worker, and may be assumed to accurately match the actual object size.

The processor 120 may calculate an actual training loss value by calculating a difference between the first bounding box value generated through the deep learning model and the second bounding box value.

In addition, the predicted loss value is as follows.

It may be assumed that bounding box values including a coordinate of a bounding box for each of the at least one object included in the predetermined image are calculated through the calculation in the deep learning model. In this case, the processor 120 may predict a sum of error degrees of the bounding box values through the deep learning model, and set the predict sum of the error degrees as the (predicted) loss value.

In other words, since the (predicted) loss value represents the sum of the error degrees of the bounding box values, even when a plurality of objects are included, one image may have one (predicted) loss value.

The deep learning model may predict the loss value as well as the actual training loss value. In other words, both the predicted loss value and the actual training loss value between the generated bounding box and a correct answer labeling bounding box may be calculated through the deep learning model.

In addition, with regard to the deep learning model, the deep learning model may be trained through an error between the training loss value and the predicted loss value.

Further, the classification value calculated by performing the calculation in the deep learning model may represent the type of the object, and may be expressed as a probability value.

For example, the classification value may include a 70% probability of the object being a vehicle, a 75% probability of the object being a human, and the like.

For reference, the classification value may be a value for each object included in the predetermined image, and several classification values may be present in one predetermined image.

Next, the processor 120 may determine a difficulty level of the labeling work based on the (predicted) loss value and the classification value, and distribute the labeling work to a worker according to the determined difficulty level (S430).

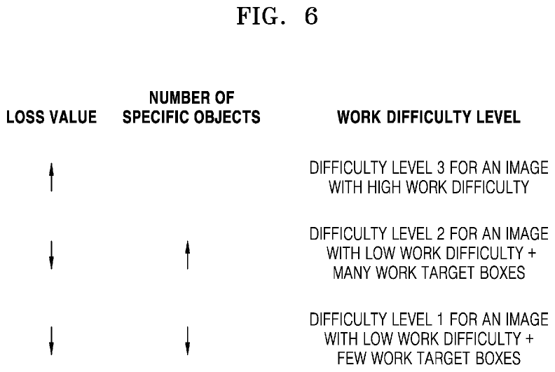

FIG. 6 is a view showing a state in which a difficulty level of the labeling work is determined according to one embodiment of the present invention.

For reference, it may be assumed that a plurality of difficulty levels are provided, and the difficulty levels include a (k+2)^{th} level, a (k+1)^{th} level, and a kth level in a descending order of difficulty. As shown in FIG. 6, Level 3 may have a highest difficulty level, and Level 1 may have a lowest difficulty level.

The processor 120 may derive a specific object having a classification value that is greater than or equal to a preset value (e.g., 0.95, etc.) from the at least one object included in the predetermined image. For reference, the classification value may represent probability that the object represents any one type of object (e.g., a vehicle, a chair, a person, etc.), and probability of representing a corresponding object may be 100% when the value is 1.

Accordingly, the processor 120 may calculate a number of specific objects having the classification value that is greater than or equal to the preset value (e.g., 0.95, etc.) among objects included in the predetermined image.

In other words, while any type of object such as a vehicle, a chair, or a person is included in the predetermined image, when the classification value is greater than or equal to 0.95, the object may be included in the number of the specific objects as a specific object. For reference, the classification value may be also referred to as a confidence score.

The processor 120 may determine the difficulty level of the labeling work by primarily considering the loss value described above and then secondarily considering the classification value. In detail, in a case of an image having a small (predicted) loss value, when the number of the specific objects having the classification value that is greater than or equal to the preset value is small, the labeling work may be determined as having a lower difficulty level, which will be described with reference to FIG. 6.

FIG. 6 is a view showing the state in which the work difficulty level is determined according to on embodiment of the present invention. For reference, the work difficulty level may be classified into the (k+2)^{th} level, the (k+1)^{th} level, and the kth level in the descending order of difficulty.

In detail, the processor 120 may set the difficulty level to the (k+2)^{th} level that is a high difficulty level when the (predicted) loss value is greater than or equal to a predetermined value. The loss value that is greater than or equal to the predetermined value may represent that an error of the bounding box calculated by the deep learning model is greater than or equal to the predetermined value, and the work difficulty level may become higher as the error becomes greater.

For reference, a high (predicted) loss value may represent a low prediction success rate in the deep learning model, that is, high difficulty of the labeling work. As described above, the processor 120 may preferentially set a case of the labeling work having the high difficulty as a labeling work target.

In addition, the processor 120 may set the difficulty level to the (k+1)^{th} level when the loss value is less than the predetermined value, and the number of the specific object is greater than a predetermined number, and may set the difficulty level to the k^{th} level when the loss value is less than the predetermined value, and the number of the specific objects is less than or equal to the predetermined number.

A case where the loss value is less than the predetermined value may correspond to an image having low work difficulty. In other words, both cases of the (k+1)^{th} level and the kth level may consider an image having low work difficulty.

Meanwhile, when the number of the specific objects having the classification value that is greater than or equal to the preset value (e.g., 0.95) among the objects included in the predetermined image is determined to be large, the processor 120 may determine that many work targets are present in the predetermined image, and may also set the difficulty to the (k+1)^{th} level, which is a rather difficult level.

On the contrary, when the number of the specific objects is determined to be small, the processor 120 may determine that few work targets are present in the predetermined image, and may also set the difficulty to the kth level, which is also an easy level.

As described above, after the difficulty level is determined for the predetermined image, the processor 120 may distribute the labeling work to the worker according to the difficulty level.

In this case, the workers may be classified by grades according to skill levels. In detail, a worker having great experience and a high skill level may be classified as a worker having a high grade, and a worker having less experience and a low skill level may be classified as a worker having a low grade.

The processor 120 of the computing apparatus 100 may provide a labeling work corresponding to a level matching the worker to a terminal 200 of the worker, and differentially provide a reward to the terminal 200 of the worker according to difficulty of the labeling work.

In other words, in a case of an image having high work difficulty (the (k+2)^{th} level), the processor 120 may distribute the image to the worker having the high grade. In addition, in a case of an image having low work difficulty (the k^{th} level), the processor 120 may distribute the image to the worker having the low grade.

In addition, the processor 120 may provide a greater reward to the worker as the difficulty of the labeling work becomes higher, and may provide a lower reward to the worker as the difficulty of the labeling work becomes lower.

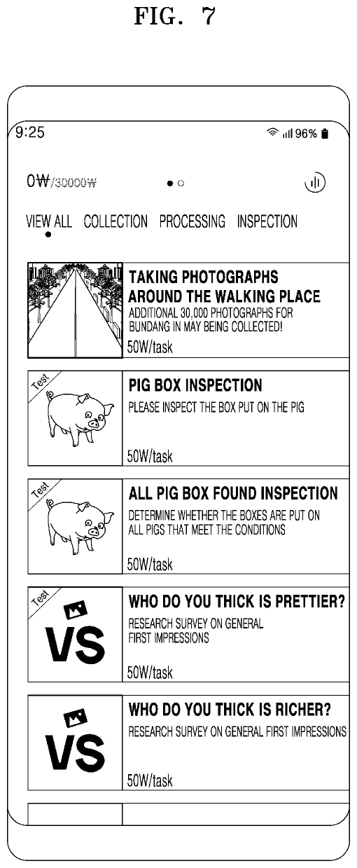

FIG. 7 is a view showing a state in which a plurality of labeling works are displayed according to one embodiment of the present invention.

The processor 120 of the computing apparatus 100 may receive difficulty information of a specific work that will be performed by the worker from the worker terminal 200. The specific work difficulty information may be directly selected by the worker, or work difficulty corresponding to a grade of the worker may be automatically selected.

The processor 120 may display only a specific labeling work matching the specific work difficulty information among a plurality of labeling works on the worker terminal 200.

FIG. 7 shows a state in which the processor 120 displays the labeling works on the worker terminal 200, in which inspection of a bounding box for a pig image, inspection of a bounding box for an object present in a surrounding photograph image, and the like are variously provided as the labeling works.

In this case, the processor 120 may provide only a specific labeling work corresponding to difficulty that may be performed by the worker to the worker terminal 200.

Unlike the above configuration, the processor 120 may provide all of the labeling works as well as the specific labeling work.

When all of the labeling works are displayed, the processor 120 may put a separate mark on each of a labeling work that may be performed by the worker and a labeling work that may not be performed by the worker according to the grade of the worker among the labeling works. The separate mark may include various marks such as a color and a flag.

In addition, the labeling works displayed on the worker terminal 200 may be displayed together with the work difficulty and a reward level.

The worker may select a work to be performed by the worker from the labeling works (or the specific labeling work) displayed on the worker terminal 200 based on information on the labeling works (or the specific labeling work).

The above-described process of displaying the labeling work on the worker terminal 200 may correspond to crowdsourcing. In other words, the processor 120 may distribute the labeling work to the worker by using the crowdsourcing.

For reference, the crowdsourcing is a compound word of crowd and outsourcing, and refers to an operation of allowing the public to participate in some process of business activities. According to the present invention, the public may participate in performing the labeling work, and various labeling works that are difficult to be collected with a small number of people may be performed.

Meanwhile, as described with reference to FIGS. 2 and 5, a self-learning process may be performed in the deep learning model according to the present invention. In this case, the self-learning process may be performed by combining at least one parameter for performing calculation of the deep learning model.

In this case, it may be assumed that a second bounding box (correct answer bounding box) matching a training object included in a training image is present. The second bounding box may represent a box considered accurately match an object included in an image, and may correspond to a result generated after a work is performed by a worker or the like.

The processor 120 of the computing apparatus 100 may perform calculation in the deep learning model by using the training image as an input value, calculate a first bounding box (training bounding box) for the training object, and calculate a predicted loss value corresponding to a sum of coordinate and classification error degrees of the calculated first bounding box.

In addition, the processor 120 may derive first comparison data by comparing a degree of similarity between the first bounding box and the second bounding box, and adjust at least one parameter of the deep learning model based on the first comparison data so as to train the deep learning model. In other words, the processor 120 may adjust the parameter so that a first comparison data value becomes 0 due to a high degree of similarity between the first bounding box generated by the deep learning model and the second bounding box.

For reference, a similarity state between the first bounding box and the second bounding box may be determined by comparison based on a coordinate and a classification of each of the bounding boxes.

In addition, as described above with reference to FIG. 5, the loss value may be predicted in the deep learning model. In this case, the predicted loss value may correspond to a sum of coordinate and classification error degrees of a first bounding box of each of objects included in the training image.

Therefore, the processor 120 may derive second comparison data by comparing a degree of similarity between the predicted loss value and the first comparison data (the training loss value of FIG. 5).

In addition, the processor 120 may adjust the at least one parameter of the deep learning model based on the second comparison data so as to retrain the deep learning model. In other words, the processor 120 may adjust the parameter so that a second comparison data value becomes 0 due to a high degree of similarity between the (predicted) loss value and the first comparison data.

The embodiments according to the present invention described above may be implemented in the form of a program instruction that may be executed through various computer components, and may be recorded in a computer-readable recording medium. The computer-readable recording medium may include a program instruction, a data file, a data structure, and the like, alone or in combination with each other. The program instruction recorded on the computer-readable recording medium may be specially designed and configured for the present invention, or may be known and available to those skilled in the art of computer software. An example of the computer-readable recording medium includes magnetic media such as a hard disk, a floppy disk, and a magnetic tape, optical recording media such as a CD-ROM and a DVD, magneto-optical media such as a floptical disk, and a hardware device specially configured to store and execute a program instruction, such as a ROM, a RAM, and a flash memory. An example of the program instruction includes a high-level language code that may be executed by a computer by using an interpreter or the like, as well as a machine language code such as those generated by a compiler. The hardware device may be configured to operate as at least one software module to perform the processing according to the present invention, and vice versa.

Although the present invention has been described above by specified embodiments and drawings as well as certain matters such as specific elements, the embodiments and drawings are provided only to assist an overall understanding of the present invention, so the present invention is not limited to the embodiments, and various changes and modifications can be made from the above description by a person having ordinary skill in the art to which the present invention pertains.

Therefore, the idea of the present invention should not be construed as being limited to the embodiments described above, and the scope of the idea of the present invention encompasses the scope of the appended claims and all variations equivalent thereto or modified equivalently thereto.

1. A method for distributing a labeling work, in which a computing apparatus uses a deep learning model for performing a work for finding a position of an object included in an image in a form of a bounding box and classifying a type of the object, the method comprising:
(a) obtaining, by the computing apparatus, a predetermined image including at least one object;
(b) performing, by the computing apparatus, calculation while passing the predetermined image through the deep learning model to calculate i) a coordinate of a bounding box for the at least one object, ii) a classification value representing a type of the at least one object, and iii) a loss value representing predicted coordinate and classification error degrees of a calculated bounding box; and
(c) determining, by the computing apparatus, a difficulty level of the labeling work based on the loss value and the classification value, and distributing the labeling work to a worker according to the determined difficulty level.

2. The method of claim 1, wherein, when a plurality of difficulty levels are provided, and the difficulty levels include a (k+2)^{th} level, a (k+1)^{th} level, and a kth level in a descending order of difficulty,
the computing apparatus is configured to:
derive a specific object having a classification value that is greater than or equal to a preset value from the at least one object; and
i) set the difficulty level to the (k+2)^{th} level when the loss value is greater than or equal to a predetermined value, ii) set the difficulty level to the (k+1)^{th} level when the loss value is less than the predetermined value, and a number of specific objects is greater than a predetermined number, and iii) set the difficulty level to the k^{th} level when the loss value is less than the predetermined value, and the number of the specific objects is less than or equal to the predetermined number.

3. The method of claim 2, wherein, when the worker is classified by a grade according to a skill level,
the computing apparatus is configured to provide a labeling work corresponding to a level matching the worker to a terminal of the worker, and differentially provide a reward to the terminal of the worker according to difficulty of the labeling work.

4. The method of claim 1, wherein, in the step (b),
when coordinate and classification error degrees of a bounding box for each of the at least one object included in the predetermined image are calculated through the calculation in the deep learning model,
the computing apparatus is configured to calculate a predicted value for a sum of the coordinate and classification error degrees of the bounding boxes, and set the calculated predicted value as the loss value.

5. The method of claim 1, wherein, when specific work difficulty information corresponding to a selection of the worker or a grade of the worker is received from a terminal of the worker,
the computing apparatus is configured to display a specific labeling work matching the specific work difficulty information among a plurality of labeling works on the terminal of the worker.

6. The method of claim 1, wherein, before the step (a),
while at least one parameter is present to perform the calculation of the deep learning model, when a correct answer bounding box matching a training object included in a training image is present,
the method further comprises:
(a1) performing, by the computing apparatus, calculation in the deep learning model by using the training image as an input value, calculating a training bounding box for the training object included in the training image, and calculating a predicted loss value corresponding to a sum of coordinate and classification error degrees of the calculated training bounding box;
(a2) deriving, by the computing apparatus, first comparison data by comparing a degree of similarity between the training bounding box and the correct answer bounding box, and adjusting at least one parameter of the deep learning model based on the first comparison data; and
(a3) deriving, by the computing apparatus, second comparison data by comparing a degree of similarity between the first comparison data and the predicted loss value, and adjusting the at least one parameter of the deep learning model based on the second comparison data.

7. The method of claim 1, wherein the computing apparatus is configured to distribute the labeling work to the worker by using crowdsourcing.

8. A computing apparatus, which is an apparatus for distributing a labeling work, in which the computing apparatus uses a deep learning model for performing a bounding box labeling work to find a positon of an object included in an image and classify a type of the object, the computing apparatus comprising:
a communication unit for obtaining a predetermined image including at least one object; and
a processor for performing calculation while passing the predetermined image through the deep learning model to calculate i) a coordinate of a bounding box for the at least one object, ii) a classification value representing a type of the at least one object, and iii) a loss value representing an error degree of a calculated bounding box, determining a difficulty level of the labeling work based on the loss value and the classification value, and distributing the labeling work to a worker according to the determined difficulty level.
